(19) United States
(12) Patent Application Publication
(10) Pub. No.: US 2014/0062320 A1
(43) Pub. Date: Mar. 6, 2014

(54) LIGHTING CONTROL CIRCUIT, LAMP, AND LIGHTING CONTROL METHOD USING THE LIGHTING CONTROL CIRCUIT

(71) Applicants: Masaharu Urano, Kanagawa (JP); Hidefumi Nakashima, Kanagawa (JP); Shigemi Hagiwara, Kanagawa (JP)

(72) Inventors: Masaharu Urano, Kanagawa (JP); Hidefumi Nakashima, Kanagawa (JP); Shigemi Hagiwara, Kanagawa (JP)

(73) Assignee: Ricoh Company, Ltd., Tokyo (JP)

(21) Appl. No.: 14/013,455

(22) Filed: Aug. 29, 2013

(30) Foreign Application Priority Data
Aug. 31, 2012 (JP) 2012-191133

(51) Int. Cl. H05B 33/08

(52) U.S. Cl. CPC H05B 33/0815
USPC 315/186

(57) ABSTRACT

A lighting control circuit includes a rectifier connected to an electric ballast to which a commercial AC power is supplied, and configured to convert an AC to a DC, a series light emitter a plurality of solid-state light-emitting elements is connected in series, a smoothing capacitor provided in parallel with the series light emitter in a current supply line between the rectifier and the series light emitter, and configured to eliminate an AC component included in the DC from an output side of the rectifier, and a switching control circuit configured to generate an output voltage equal to an output voltage from the electric ballast when a fluorescent lamp starts up upon the connection of the fluorescent lamp to the electric ballast as a startup voltage in the startup of the series light emitter.

### PRIORITY CLAIM

The present application is based on and claims priority from Japanese Patent Application No. 2012-191133, filed on Aug. 31, 2012, the disclosure of which is hereby incorporated by reference in its entirety.

### BACKGROUND

1. Field of the Invention

The present invention relates to a lighting control circuit for use in controlling lighting of a solid-state light-emitting element, a lamp, and a lighting control method using the lighting control circuit.

2. Description of the Related Art

A lamp using, for example, a light-emitting diode (LED) as a battery-friendly solid-state light-emitting element is proposed instead of a fluorescent lamp having filament electrodes (refer to, for example, JP2008-277188A).

According to the technique disclosed in JP2008-277188A, a lamp having a solid-state light-emitting element can be exchangeably attached not only to a lighting device for a glow starter fluorescent lamp or a rapid starter fluorescent lamp but also to a lighting device having an inverter electronic ballast for a fluorescent lamp.

However, in a case of attaching a lamp having a rectifier circuit, smoothing circuit, and solid-state light-emitting element to an electronic ballast of a fluorescent lamp, a lamp different from a commercial fluorescent lamp is connected to an electronic ballast of a fluorescent lamp, so that a protection operation of the electronic ballast operates, which may disturb the lighting of the lamp.

Unstable lighting of a lamp is a generally known fact. In order to avoid such unstable lighting of the lamp, the output voltage of the electric ballast is set to be a voltage (equal voltage) close to the output voltage while a fluorescent lamp is connected to the electric ballast when the lamp is connected to the electric ballast instead of the fluorescent lamp.

However, when the output voltage while the lamp is connected to the electric ballast is set to be close to the output voltage while the fluorescent lamp is connected to the electric ballast, the protection operation of the electric ballast becomes difficult to operate. Therefore, it is disadvantageous in electric power saving although it is advantageous in stable lighting of a lamp.

On the other hand, when the output voltage while the lamp is connected to the electric ballast is set to be lower than the output voltage while the fluorescent lamp is connected to the electric ballast, the electric power saving can be improved, but the lighting of the lamp becomes unstable.

### SUMMARY

The present invention has been made in view of the above circumstances, and an object of the present invention is to provide a lighting control circuit capable of stably lighting a lamp using a solid-state light-emitting element and saving power even when the lamp using the solid-state light-emitting element is connected to an electric ballast, a lamp and a lighting control method using the lighting control circuit.

To attain the above object, one embodiment of the present invention provides a lighting control circuit including: a rectifier connected to an electric ballast to which a commercial AC power is supplied, and configured to convert an AC to a DC; a series light emitter a plurality of solid-stale light-emitting elements is connected in series; a smoothing capacitor provided in parallel with the series light emitter in a current supply line between the rectifier and the series light emitter, and configured to eliminate an AC component included in the DC from an output side of the rectifier; and a switching control circuit configured to generate an output voltage equal to an output voltage from the electric ballast when a fluorescent lamp starts up upon the connection of the fluorescent lamp to the electric ballast as a startup voltage in the startup of the series light emitter, and switch the series light emitter to a parallel connector made up of series connection of a plurality of solid-state light-emitting elements after a predetermined time has passed since the startup of the series light emitter.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 is a sectional view illustrating an outline of a lighting device having an electric ballast for an existing fluorescent lamp to which a lamp having a solid-state light-emitting element according to an embodiment of the present invention is attached.

FIG. 2 is a front view illustrating an external appearance of a lamp which is attachable to the lighting device illustrated in FIG. 1.

FIG. 3 is a connecting diagram of Embodiment 1 of a lighting control circuit of a lamp using the solid-state light-emitting element according to the present invention.

FIG. 4 is a view describing a voltage waveform output from a rectifier illustrated in FIG. 3.

FIG. 5 is a connecting diagram of a modified example of the lighting control circuit illustrated in FIG. 3.

FIG. 6 is a connecting diagram of Embodiment 2 of a lighting control circuit of a lamp using the solid-state light-emitting element according to the present invention.

FIG. 7 is a connecting diagram of Embodiment 3 of a lighting control circuit of a lamp using the solid-state light-emitting element according to the present invention.

### DETAILED DESCRIPTION OF THE PREFERRED EMBODIMENTS

### Embodiments

Hereinafter, a lighting control circuit, a lamp, and a lighting control method using the lighting control circuit according to the embodiments of the present invention will be described with reference to the drawings.

FIG. 1 is an external view illustrating an outline of a lighting device including an electric ballast for an existing fluorescent lamp to which a lamp having a solid-state light-emitting clement according to the present invention can be attached.

### (Common Configuration)

Referring to FIG. 1, reference number 1 denotes a reflector on which the after-described straight lamp is mounted. The reflector 1 is provided with a pair of sockets 2 to have a space therebetween. A pair of the sockets 2 is provided in both ends of the reflector 1 in the extending direction thereof. The reflector 1 is provided with an existing electric ballast 3 for a fluorescent lamp to which power from a commercial AC source can be supplied.

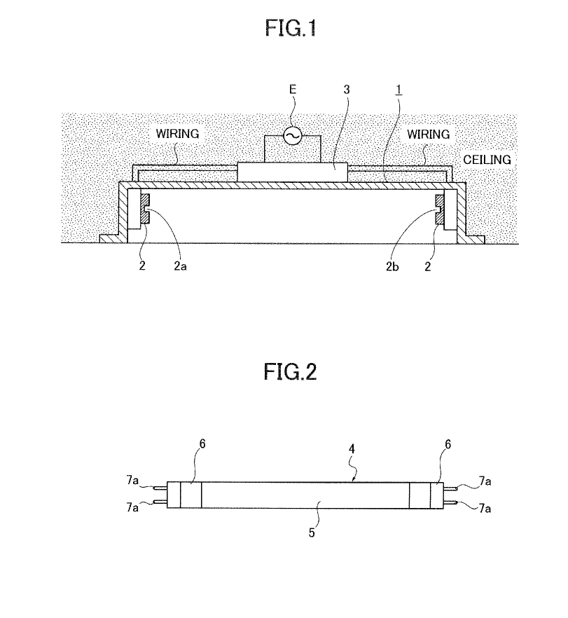

An existing straight fluorescent lamp can be mounted on the lighting device. In this case, a straight lamp 4 illustrated in FIG. 2 can be attached instead of the existing straight fluorescent lamp. Both end portions of a straight tube 5 of the lamp 4 are sealed by a pair of caps 6. A pair of electrode pins 7a, 7a constituting a part of a power supply system is provided in each of the caps 6.

A commercial AC source E is connected to the electric ballast 3. The frequency of the commercial AC source E is, for example, 50 Hz/60 Hz. The output sides of the electric ballast 3 are connected to a pair of sockets 2. Each of the sockets 2 includes a pair of electrode terminals 2a, 2b. A pair of electrode pins 7a, 7a is connected to the pair of electrode terminals 2a, 2b.

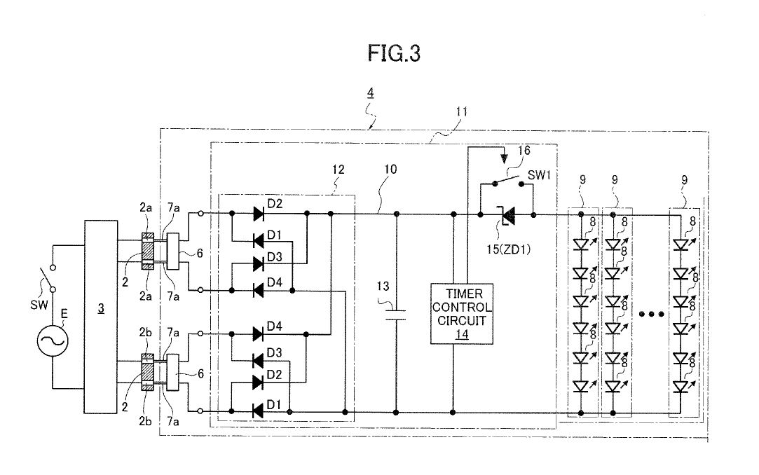

As illustrated in FIG. 3, a plurality of solid-state light-emitting elements (for example, light-emitting diode (LED)) 8 and a lighting control circuit 11 are provided inside the straight tube 5. A plurality of solid-state light-emitting elements 8 is connected in series, and constitutes a series light emitter 9 made up of a series connector. In this embodiment, at least three series light emitters 9 are arranged in parallel.

### Embodiment 1

The lighting control circuit 11 includes a current supply line 10, rectifier 12, smoothing capacitor 13, timer control circuit 14, impedance element 15, and short-circuiting switching element (SW1) 16. The rectifier 12 is connected to the electric ballast 3 to which power is supplied from the commercial AC source E so as to convert an AC into a DC.

It is preferable for the rectifier 12 to be made up of a bridge-type full-wave rectifier circuit having rectifier diodes D1-D4. The input side of each rectifier 12 is connected to a pair of electrode pins 7a, 7a. The output side of each rectifier 12 is connected to the electrodes of both ends of the smoothing capacitor 13.

The smoothing capacitor 13 operates to eliminate an AC component included in the DC output from the output side. Both ends of each series light emitter 9 are connected to the electrodes of both ends of the smoothing capacitor 13 parallel through the current supply line 10.

The impedance element 15 is provided in series in the current supply line 10 between the rectifier 12 and the series light emitter 9. The impedance element 15 operates to generate an output voltage equal to an output voltage from the electric ballast 3 when a fluorescent lamp starts up upon the connection of the fluorescent lamp to the electric ballast 3 as a startup voltage in the startup of the lamp 4 (series light emitter 9).

A Zener diode (ZD1) is used for the impedance element 15 in this case, but a resistor or an inductor can be used. A short-circuiting switching element 16 is connected to the impedance element 15 in parallel. A semiconductor switching element can be used for the short-circuiting switching element 16, but a relay switch or a mechanical switch can be used.

The timer control circuit 14 operates to set the output voltage from the electric ballast 3 to be lower than the startup voltage by short-circuiting the short-circuiting switching element 16 after at least a predetermined time (corresponding to preheat time of filament of fluorescent lamp) corresponding to an energization time to the filament of the fluorescent lamp has passed since the startup of the lamp 4.

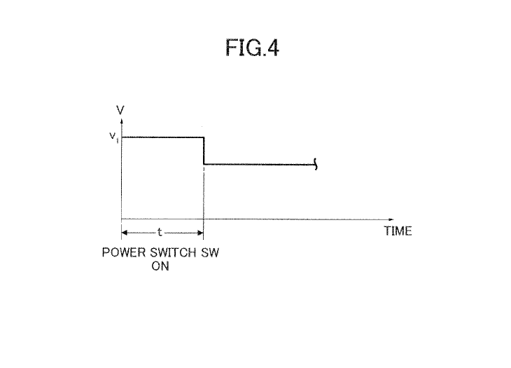

Namely, the electric ballast 3 is turned on in response to the turning on of the power source switch SW illustrated in FIG. 3, and the startup voltage V1 equal to the output voltage from the electric ballast 3 when a fluorescent lamp starts up upon the connection of the fluorescent lamp to the electric ballast 3 is generated during at least a predetermined time t corresponding to the energization time to the filament of the fluorescent lamp after the startup of the series light emitter 9 as illustrated in FIG. 4.

Next, the timer control circuit 14 closes the short-circuiting switching element 16 after a predetermined time t has passed since the startup. The impedance element 15 is thereby short-circuited, and the output voltage V from the electric ballast 3 is set to be lower than the startup voltage V1 as illustrated in FIG. 4.

According to this embodiment, a control step of applying the output voltage equal to the output voltage V1 from the electric ballast 3 when a fluorescent lamp starts up upon the connection of the fluorescent lamp to the electric ballast 3 to the series light emitter 9 in the startup of the series light emitter 9, and a control step of setting the output voltage V from the electric ballast 3 to be lower than the startup voltage V1 after at least a predetermined time t corresponding to the energisation time to the filament of the fluorescent lamp has passed since the startup of the series light emitter 9 are executed.

Namely, the smoothing capacitor 13 is electrically connected to the series light emitter 9 in parallel, the impedance element 15 is provided in the current supply line 10 which supplies a current to the series light emitter 9, and the short-circuiting switching element 16 is provided in the impedance element 15 in parallel. With this configuration, the control step of applying the output voltage V equal to the output voltage from the electric ballast 3 when a fluorescent lamp starts up upon the connection of the fluorescent lamp to the electric ballast 3 to the series light emitter 9 in the startup of the series light emitter 9 by maintaining the short-circuiting switching element 16 in an open condition during the predetermined time t after the startup of the series light emitter 9, and the control step of setting the output voltage from the electric ballast 3 to be lower than the startup voltage V1 after the predetermined time t has passed are executed.

As a result, the lamp 4 starts up by using the output voltage V of the electric ballast 3, which is close to the voltage of the fluorescent lamp, in the startup of the lamp 4, and the output voltage V of the electric ballast 3 is set to be lower than the startup voltage V1 after the stabilization of the operation of the lamp 4. Therefore, the lamp 4 using the solid-state light-emitting element 8 can be stably lighted, and lower power consumption can be achieved.

In addition, it is preferable to set a time slightly longer than a time slightly longer than a time from the energization start to the filament of the fluorescent lamp to the energization stop to the filament (preheat time: time required for lighting after fluorescent lamp starts discharging) as the predetermined time in order to stably light the solid-state light-emitting element 8.

### MODIFIED EXAMPLE

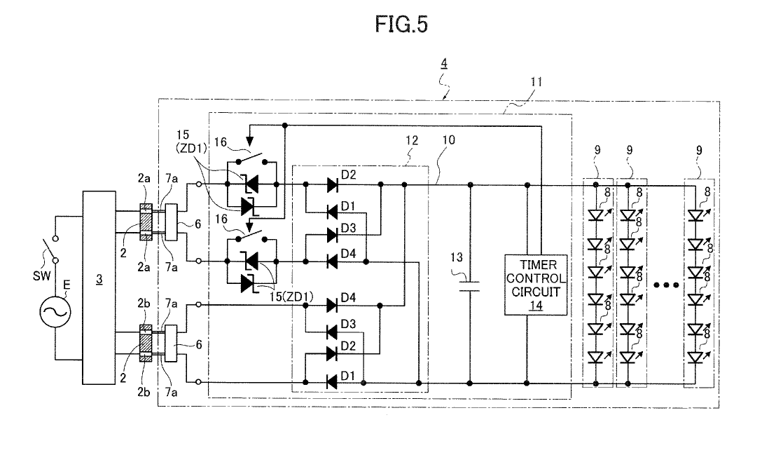

In the above embodiment, the impedance element 15 is provided in series in the current supply line 10 between the rectifier 12 and the series light emitter 9. However, as illustrated in FIG. 5, the impedance element 15 can be provided between the electric ballast 3 and the rectifier 12. The other configurations and operations of the modified example are similar to those in Embodiment 1; thus, the detailed description thereof will be omitted with only reference numbers being illustrated.

In this case, it is desirable to provide a pair of impedance elements 15 opposite to each other in the current supply line 10 in view of an AC component output from the electric ballast 3.

### Embodiment 2

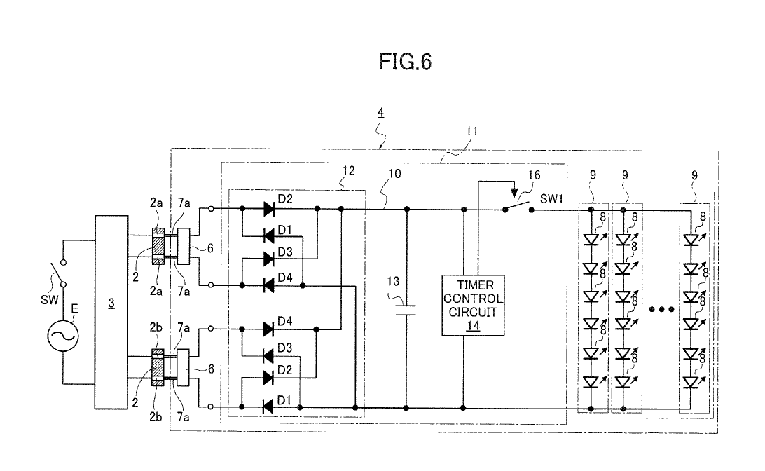

FIG. 6 is a connecting diagram of Embodiment 2 of a lighting control circuit of a lamp using a solid-state light-emitting element according to the present invention.

In this embodiment, the short-circuiting switching element 16 is provided in the current supply line 10 between the smoothing capacitor 13 and the series light emitter 9. The short-circuiting switching element 16 opens (open condition) in the startup of the series light emitter 9 and is closed (closed condition) after at least a predetermined time t has passed since the startup of the series light emitter 9, so as to generate the output voltage equal to the output voltage from the electric ballast 3 when a fluorescent lamp stalls up upon the connection of the fluorescent lamp to the electric ballast 3 as the startup voltage V1 in the startup of the series light emitter 9. The impedance element can be appropriately provided between the rectifier 12 and the smoothing capacitor 13, the rectifier 12 and the series light emitter 9, or the like.

The tuner control circuit 14 operates to close the short-circuiting switching element 16 after at least a predetermined time t corresponding to the energization time to the filament of the fluorescent lamp has passed since the startup of the series light emitter 9. The output voltage from the electric ballast 3 is thereby lowered.

According to Embodiment 2, a control step of applying the output voltage V1 equal to the output voltage from the electric ballast 3 when a fluorescent lamp starts up upon the connection of the fluorescent lamp to the electric ballast 3 by maintaining the short-circuiting switching element 16 in the open condition during the predetermined time t after the startup, and a control step of setting the output voltage V from the electric ballast 3 to be lower than the startup voltage V1 after the predetermined time t has passed are executed. The effects similar to those in Embodiment 1 can be therefore obtained.

### Embodiment 3

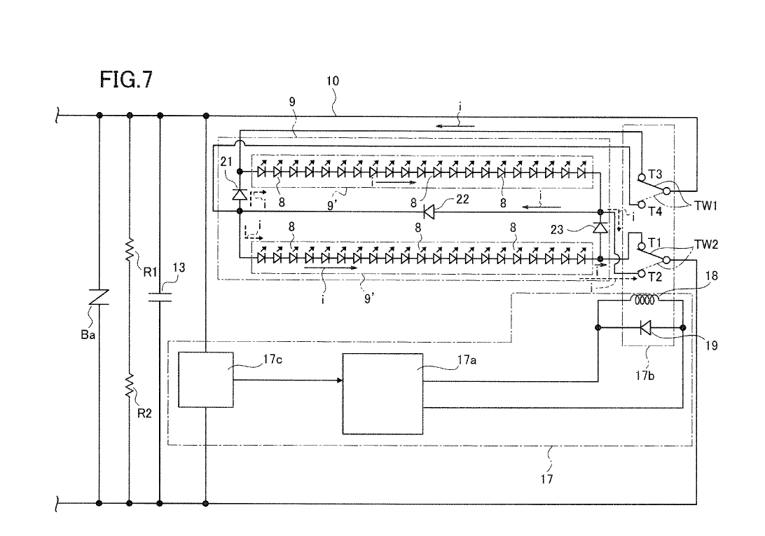

FIG. 7 is a connecting diagram of Embodiment 3 of a lighting control circuit of a lamp using a solid-state light-emitting element according to the present invention.

In this embodiment 3, in order to generate a startup voltage equal to the output voltage from the electric ballast 3 when a fluorescent lamp starts up upon the connection of the fluorescent lamp to the electric ballast 3 in the startup of the lamp 4, the series light emitter 9 includes a series connector in which 42 solid-state light-emitting elements 8 are connected in series. In this embodiment, 3 series connectors are provided in parallel. However, only one series light emitter 9 is illustrated in FIG. 7 in order to simply the illustration.

The lamp 4 is provided with a switching circuit 17, which sets the output voltage V from the electric ballast 3 to be lower than the startup voltage V1 by switching the series light emitter 9 to a parallel connector 9′ having a plurality of solid-state light-emitting elements 8 after at least a predetermined time t corresponding to the energization time to the filament of the fluorescent lamp has passed since the startup of the series light emitter 9. The parallel connector 9′ includes a series connector having 21 solid-state light-emitting elements 8.

The switching circuit 17 includes a timer circuit 17a, relay switch circuit 17b, and power stabilization circuit 17c which supplies stable voltage to the timer circuit 17a and the relay switch circuit 17b.

The relay switch circuit 17b includes a conducting coil 18, back-flow prevention diode 19 in parallel with the conducting coil 18, moving contacts TW1, TW2, and fixed contacts T1-T4.

The series light emitter 9 is provided with back-flow prevention diodes 20, 21, 22 which prevent the back flow of the conducting current when switching the series connector having 42 solid-state light-emitting elements 8 to the parallel connector 9′ having 21 solid-state light-emitting elements 8.

In Embodiment 3, the current supply line 10 is provided with resistors R1, R2 and a varistor Ba in parallel with the smoothing capacitor 13 in view of the circuit design. However, these are not essential for the present invention.

According to Embodiment 3, the relay contact TW1 is connected to the fixed contact T3 and the relay contact TW2 is connected to the fixed contact T1 in order to generate the startup voltage equal to the output voltage from the electric ballast 3 when a fluorescent lamp starts up upon the connection of the fluorescent lamp to the electric ballast 3 in the startup of the lamp 4. Current i therefore flows in the 42 solid-state light-emitting elements 8 as illustrated by the solid-state line.

The startup voltage V1 is thereby applied to the series light emitter 9 from the electric ballast 3.

The switching control circuit 17 switches the relay contact TW1 to the fixed contact T4 as illustrated by the dashed line, and switches the relay contact TW2 to the fixed contact T2 as illustrated by the dashed line after a predetermined time t has passed since the startup of the lamp 4.

As a result, the current i flows in the parallel connector 9′ made up of the series connection of the 21 solid-state light-emitting elements 8 as illustrated by the dashed line, and the output voltage V from the electric ballast 3 is set to be below the startup voltage V1 after at least a predetermined time t corresponding to the energization time to the filament of the fluorescent lamp has passed since the startup of the series light emitter 9.

More specifically, according to Embodiment 3, a control step of switching the connection condition of the series light emitter 9 from the series connection condition to the parallel connection condition made up of the series connection of the solid-state light-emitting element after at least a predetermined time t corresponding to the energization time to the filament of the fluorescent lamp has passed since the startup of the series light emitter 9 is executed. The lamp thereby starts up by using the output voltage of the electric ballast, which is close to that of a fluorescent lamp, in the startup, and the output voltage of the electric ballast is lowered after the stabilization of the operation of the lamp, so that the lamp using the solid-state light-emitting elements can be stably lighted, and a lower power consumption can be achieved.

According to the embodiments of the present invention, the lamp starts up by using the output voltage from the electric ballast, which is close to a voltage of a fluorescent lamp, and the output voltage of the electric ballast is lowered after the stabilization of the operation of the lamp. Thus, a lamp using a solid-state light-emitting element can be stably lighted, and low power consumption can be achieved.

According to one embodiment of the present invention, a lighting control circuit includes a rectifier connected to an electric ballast to which a commercial AC power is supplied, and configured to convert an AC into a DC; a series light emitter made up of a series connector including a plurality of solid-state light-emitting elements; a smoothing capacitor provided in parallel with the series light emitter in a current supply line from the electric ballast to the series light emitter which is a current supply line between the rectifier and the series light emitter, and configured to eliminate an AC component included in the DC output from an output side of the rectifier; an impedance element configured to generate an output voltage equal to an output voltage from the electric ballast when a fluorescent lamp starts up upon connection of the fluorescent lamp to the electric ballast as a startup voltage in startup of the series light emitter; a short-circuiting switching element provided in parallel with the impedance element; and a timer control circuit configured to short-circuit the short-circuiting switching element after a predetermined time has passed since the startup of the series light emitter.

Preferably, the impedance element is provided in series in the current supply line between the rectifier and the series light emitter.

Preferably, the impedance element is provided between the electric ballast and the rectifier.

Preferably, the impedance element is a Zener diode, a resistor, or an inductor.

Preferably, the short-circuiting switching element s a se conductor switching element.

According to one embodiment of the present invention, a lighting control circuit includes a rectifier connected to an electric ballast to which a commercial AC power is supplied, and configured to convert an AC to a DC; a series light emitter made up of a series connector including a plurality of solid-state light-emitting elements; a smoothing capacitor provided in parallel with the series light emitter n a current supply line from the electric ballast to the series light emitter which is a current supply line between the rectifier and the series light emitter, and configured to eliminate an AC component included in the DC output from an output side of the rectifier; a short-circuiting switching element provided in the current supply line, and configured to open in startup and to be closed after a predetermined time has passed since the startup of the series light emitter, so as to generate an output voltage equal to an output voltage from the electric ballast when a fluorescent light starts up upon the connection of the fluorescent light to the electric ballast as a startup voltage in the startup of the series light emitter; and a timer control circuit configured to change the short-circuiting switching element to be closed after the predetermined time has passed since the startup of the series light emitter.

Preferably, the short-circuiting switching element is provided in series in the current supply line between the rectifier and the series light emitter.

Preferably, the short-circuiting switching element is provided between the electric ballast and the rectifier.

According to one embodiment of the present invention,a lamp includes a straight tube, both ends of which are sealed by a cap having a pair of electrode pins, the straight tube including inside thereof: a rectifier connected to an electric ballast to which a commercial AC power is supplied, and configured to convert an AC into a DC; a series light emitter made up of a series connector including a plurality of solid-state light-emitting elements; a smoothing capacitor provided in parallel with the series light emitter in a current supply line from the electric ballast to the series light emitter which is a current supply line between the rectifier and the series light emitter, and configured to eliminate an AC component included in the DC output from an output side of the rectifier; an impedance element configured to generate an output voltage equal to an output voltage from the electric ballast when a fluorescent lamp starts up upon connection of the fluorescent lamp to the electric ballast as a startup voltage in startup of the series light emitter; a short-circuiting switching element provided in parallel with the impedance element; and a timer control circuit configured to short-circuit the short-circuiting switching element after a predetermined time has passed since the startup of the series light emitter.

According to one embodiment of the present invention, a lamp includes a straight tube, both ends of which are sealed by a cap having a pair of electrode pins, the straight tube including inside thereof: a rectifier connected to an electric ballast to which a commercial AC power is supplied, and configured to convert an AC to a DC; a series light emitter made up of a series connector including a plurality of solid-state light-emitting elements; a smoothing capacitor provided in parallel with the series light emitter in a current supply line from the electric ballast to the series light emitter which is a current supply line between the rectifier and the series light emitter, and configured to eliminate an AC component included in the DC output from an output side of the rectifier; a short-circuiting switching element provided in the current supply line, and configured to open in startup and to be closed after a predetermined time has passed since the startup of the series light emitter, so as to generate an output voltage equal to an output voltage from the electric ballast when a fluorescent light starts up upon the connection of the fluorescent light to the electric ballast as a startup voltage in the startup of the series light emitter; and a timer control circuit configured to change the short-circuiting switching element to be closed after the predetermined time has passed since the startup of the series light emitter.

Although the embodiments of the present invention have been described above, the present invention is not limited thereto. It should be appreciated that variations may be made in the embodiments and the aspects described by persons skilled in the art without departing from the scope of the present invention.

What is claimed is:

1. A lighting control circuit comprising:
a rectifier connected to an electric ballast to which a commercial AC power is supplied, and configured to convert an AC to a DC;
a series light emitter a plurality of solid-state light-emitting elements is connected in series;
a smoothing capacitor provided in parallel with the series light emitter in a current supply line between the rectifier and the series light emitter, and configured to eliminate an AC component included in the DC from an output side of the rectifier; and
a switching control circuit configured to generate an output voltage equal to an output voltage from the electric ballast when a fluorescent lamp starts up upon the connection of the fluorescent lamp to the electric ballast as a startup voltage in the startup of the series light emitter, and switch the series light emitter to a parallel connector made up of series connection of a plurality of solid-state light-emitting elements after a predetermined time has passed since the startup of the series light emitter.

2. A lamp comprising:
a straight tube, both ends of which are sealed by a cap having a pair of electrode pins,
the straight tube including inside thereof:
a rectifier connected to an electric ballast to which a commercial AC power is supplied, and configured to convert an AC to a DC;
a series light emitter in which a plurality of solid-state light-emitting elements is connected in series;
a smoothing capacitor provided in parallel with the series light emitter in a current supply line between the rectifier and the series light emitter, and configured to eliminate an AC component included in the DC output from an output side of the rectifier; and
a switching control circuit configured to generate an output voltage equal to an output voltage from the electric ballast when a fluorescent lamp starts up upon the connection of the fluorescent lamp to the electric ballast as a startup voltage in the startup of the series light emitter, and switch the series light emitter to a parallel connector made up of series connection of a plurality of solid-state light-emitting elements after a predetermined time has passed since the startup of the series light emitter.

3. A lighting control method of a lamp in which a series light emitter made up of a series connector including a plurality of solid-state light-emitting elements is provided inside a straight tube, both ends which are sealed by a cap having a pair of electrode pins, and the lamp being used instead of a fluorescent lamp by connecting to an electric ballast to which a commercial AC power is supplied; comprising:
a control step of applying an output voltage equal to a startup voltage output from the electric ballast when the fluorescent lamp starts up upon the connection of the fluorescent lamp to the electric ballast to the series light emitter in the startup of the series light emitter; and
a control step of setting the output voltage from the electric ballast to be lower than the startup voltage after a predetermined time has passed since the startup of the series light emitter.

4. The lighting control method according to claim 3 further comprising:
a step of providing an impedance element in a current supply line which supplies a current to the series light emitter upon the electric connection of a smoothing capacitor in parallel with the series light emitter, and providing a short-circuiting switching element in parallel with the impedance element;
a control step of applying an output voltage equal to a startup voltage output from the electric ballast when a fluorescent lamp starts up upon the connection of the electric ballast by maintaining the short-circuiting switching element in an open condition during a predetermined time after startup of the series light emitter; and
a control step of setting the output voltage from the electric ballast to be lower than the startup voltage after the predetermined time has passed.

5. The lighting control method according to claim 3 further comprising:
a control step of applying an output voltage equal to a startup voltage output from the electric ballast when the fluorescent lamp starts up upon the connection of the fluorescent lamp by maintaining a current supply line which supplies a current to the series light emitter upon the electric connection of a smoothing capacitor n parallel with the series light emitter in an open condition during the predetermined time after startup of the series light emitter; and
a control step of setting the output voltage from the electric ballast to be lower than the startup voltage after a predetermined time has passed.

6. The lighting controlling method according to claim 3, wherein the output voltage from the electric ballast is set to be lower than the startup voltage by switching the connection condition of the series light emitter from a series connection condition to a parallel connection condition made up of series connection of a plurality of solid-state light-emitting elements.
